(19) United States
(12) Patent Application Publication
(10) Pub. No.: US 2001/0012293 A1
(43) Pub. Date: Aug. 9, 2001

(54) SIMULTANEOUS TRANSMISSION OF VOICE AND NON-VOICE DATA ON A SINGLE NARROWBAND CONNECTION

(76) Inventors: LARS-GORAN PETERSEN, TUMBA (SE); GOSTA LEIJONHUFVUD, HUDDINGE (SE)

Correspondence Address: BURNS DOANE SWECKER & MATHIS L L P, POST OFFICE BOX 1404, ALEXANDRIA, VA, 22313-1404, US

(21) Appl. No.: 08/982,425

(22) Filed: Dec. 2, 1997

(51) Int. Cl. H04B 1/38; H04L 5/16; H04L 12/28; H04L 12/56; H04L 12/66; H04J 3/16; H04J 3/22; H04J 1/02; H04J 3/04; H04J 3/02

(52) U.S. Cl. 370/389; 370/463; 370/466; 370/493; 370/535; 375/222

(57) ABSTRACT

In a publically switched telephone network (PSTN), a method and a system for simultaneously and independently multiplexing voice and non-voice data over a single, commonly shared PSTN access line. This is accomplished by packetizing the voice and non-voice data into minicells, and then multiplexing the minicells into a single data stream for transportation across the commonly shared PSTN access line. Once the minicells containing either voice or non-voice data have been transported over the single, commonly shared PSTN access line, the data is simultaneously and independently routed to distinctly different end-users according to the routing information stored in the header portion of each minicell.

### BACKGROUND

The present invention relates to the transmission of telecommunications data. More particularly, the present invention relates to the simultaneous and independent transmission of voice and non-voice data over a single, narrowband publically switched telephone network (PSTN) access line.

Most individuals who access the internet do so through a personal computer located in their home or in their business office. Typically, internet data is transmitted between the personal computer and an internet service provider over a PSTN access line, as illustrated in FIG. 1. Since the internet data is digital data, modems, such as the modems 105 and 110 depicted in FIG. 1, must be employed at either end of the PSTN access line 115 in order to convert the digital data into analog signals that are compatible with the method of transmitting data over the PSTN 115. When an individual first establishes an internet connection with an internet service provider, such as the internet service provider 120, the modems 105 and 110 at either end of the PSTN access line 115 must first agree on a data transmission rate. The transmission rate must also be compatible with the capabilities of the PSTN 115.

In many households and business offices, especially small business offices, there is only a single PSTN access line linking the household or office to the PSTN. Consequently, the personal computer must share the PSTN access line with one or more telephones located in the household or office, as illustrated in FIG. 1. Furthermore, the telephone may not be used if someone in the household or office is already using the personal computer to access the internet. Likewise, one is precluded from using the personal computer to access the internet if someone is already using the telephone.

In order to simultaneously and independently transmit both voice data and non-voice data (e.g., internet data) over a single PSTN access line, the bandwidth of the otherwise narrowband PSTN access line must be improved to minimize, or at least reduce, transmission delays caused by the additional data traffic. Although transmission delays are always undesirable, voice data is especially sensitive to such delays. However, as one skilled in the art will readily appreciate, there are numerous techniques available for improving bandwidth. For example, speech encoding algorithms such as Adaptive Differential Pulse Code Modulation (ADPCM) may be used to compress the voice data. There is both a 32 KBPS and a 16 KBPS ADPCM algorithm, both of which provide relatively good speech quality. There are also voice compression techniques, such as those employed in the transmission of cellular voice data that are based on speech analysis. These latter techniques are relatively slow compared with ADPCM. Nevertheless, they provide adequate speech quality while improving bandwidth.

Aside from improving the bandwidth of an ordinarily narrowband PSTN access line, voice and non-voice data must be multiplexed into a single data stream. Multiplexing different types of telecommunications data such as voice and non-voice data into a single stream is also relatively well-known in the art. U.S. Pat. No. 5,475,691 (Chapman et al.) describes a simultaneous voice and non-voice data modem which is capable of multiplexing and demultiplexing both voice and non-voice data over a single access line for a telephone and a data terminal respectively. In addition, U.S. Pat. No. 4,476,559 (Brolin et al.) describes a method employing a time division multiple access (TDMA) scheme to simultaneously transmit voice and non-voice data over a single transmission channel.

Despite the various voice compression techniques for improving bandwidth and the various methods for multiplexing different types of data into a single data stream, there are no designs that provide both simultaneous and independent transmission of voice and non-voice data over a common PSTN access line. More specifically, there aren't any known telecommunications designs that provide simultaneous transmission of voice and non-voice data, such as internet data, over a single PSTN access line, wherein the voice connection is established between a first set of end-users and the non-voice connection is established between a second set of end-users. It is the ability to both simultaneously and independently transmit voice and non-voice data over a single PSTN line, in a fashion that is invisible to the PSTN, that sets the present invention apart from currently existing telecommunications designs such as those described above.

### SUMMARY

It is an object of the present invention to provide the ability to simultaneously transmit both voice (e.g., telephone data) and non-voice data (e.g., internet data) over a single PSTN access line.

It is another object of the present invention to simultaneously and independently transmit voice and non-voice data over a single PSTN access line, such that the voice data connection is established between a first set of end-users, while the non-voice data is established between a second set of end-users.

It is a further object of the present invention to simultaneously and independently transmit voice and non-voice data over a single PSTN access line using techniques that take into consideration the delay sensitive, asynchronous nature of voice data.

In accordance with one aspect of the invention, the foregoing and other objects are achieved in a method, apparatus and/or system for simultaneously transmitting independent data over a single publically switched telephone network (PSTN) access line. The method, apparatus and/or system involves generating a first data packet and a second data packet, wherein the first data packet is generated by a first data source and the second data packet is generated by a second data source, independent of the first data source. The data associated with the first data packet and the data associated with the second data packet are then multiplexed into a single data stream, which is transmitted over the single PSTN access line. The single PSTN access line is commonly shared by the first and the second data sources. In accordance with this aspect of the invention, the data associated with the first data packet may be voice data, while the data associated with the second data packet may be non-voice data.

In accordance with another aspect of the invention, the foregoing and other objects are achieved in a method, apparatus and/or system for establishing a plurality of telecommunications connections over a single, commonly shared publically switched telephone network (PSTN) access line. The method, apparatus and/or system involves establishing a telecommunications link between a first and a second end-user, wherein the first end-user terminal is serviced by a PSTN access line, and establishing a telecommunications link between a third and a fourth end-user, independent of the telecommunications link between the first and the second end-user, wherein the third end-user is serviced by the PSTN access line. A first sequence of minicells associated with the first end-user is generated, and a second sequence of minicells associated with the third end-user is generated. The first sequence of minicells is transmitted from the first end-user to the second end-user over the PSTN access line, while the second sequence of minicells is transmitted from the third end-user to the fourth end-user over the PSTN access line. Moreover, the second sequence of minicells and the first sequence of minicells are transmitted over the PSTN access line simultaneously.

### BRIEF DESCRIPTION OF THE DRAWINGS

The objects and advantages of the invention will be understood by reading the following detailed description in conjunction with the drawings in which:

FIG. 1 illustrates the prior art;

FIGS. 2A and 2B show a first embodiment of the present invention;

FIG. 3 shows a second embodiment of the present invention;

FIG. 4 shows a third embodiment of the present invention;

FIG. 5 illustrates an exemplary embodiment for the multiplexer employed in the present invention;

FIG. 6 illustrates an exemplary embodiment for the demultiplexer employed in the present invention; and

FIG. 7 is a state diagram associated with the sync-state machine.

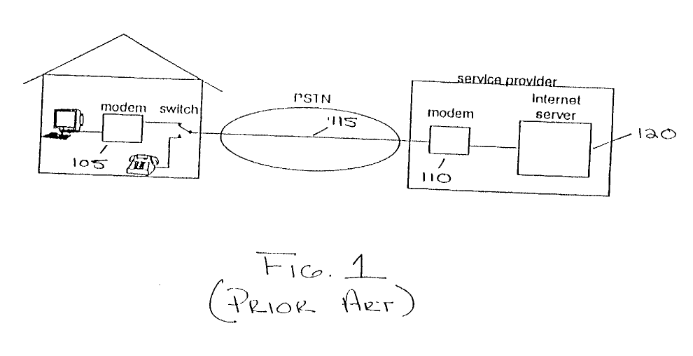

### DETAILED DESCRIPTION

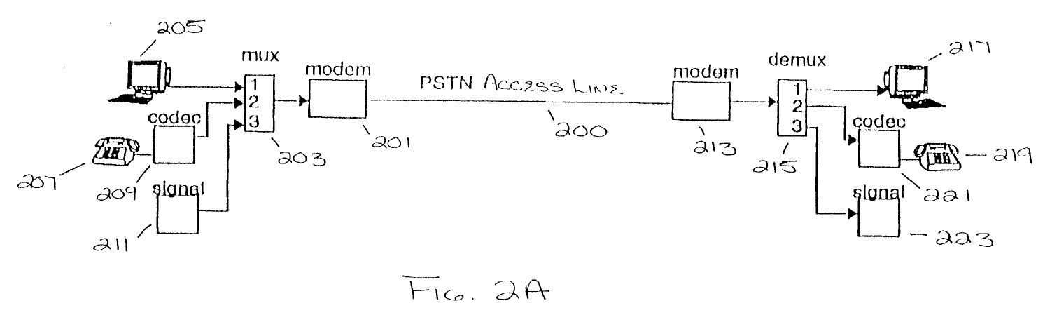

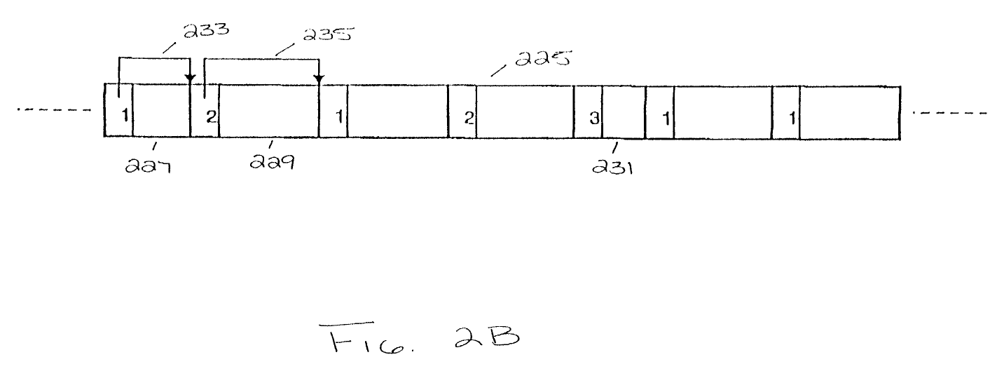

The present invention involves multiplexing and simultaneously transmitting both voice data (e.g., telephone generated speech data) and non-voice data (e.g., computer data such as internet data) using a single PSTN access line, as illustrated in FIG. 2A. For illustrative purposes only, the components to the left of the PSTN access line 200 are shown as transmitting data, as indicated by the direction of the arrows. In contrast, the components to the right of the PSTN access line 200 are shown as receiving data. However, it will be understood that the components at both ends of the PSTN access line 200 are capable of transmitting and receiving data. Accordingly, there are multiplexer and demultiplexer capabilities at both ends of the PSTN access line 200.

At the transmitting end, there are a number of components connected to the PSTN access line 200 through the modem 201 and the multiplexer 203. Among these components is a personal computer 205. The personal computer 205 represents an interface device through which an individual may access the internet. A second component at the transmitting end of the PSTN access line 200 is the telephone 207. The telephone 207 is connected through a codec 209. The codec contains the necessary coding and decoding algorithms for voice data compression and decompression. The third device is the signaling unit 211. In general, the signaling unit 211 is used for setting-up each independent connection. The signaling unit 211 will be described in greater detail below.

At the receiving end, there are a number of substantially similar components connected to the PSTN access line 200 through the modem 213 and the demultiplexer 215. These include a computer 217, a telephone 219, a codec 221 and a signaling unit 223.

In accordance with a preferred embodiment of the present invention, voice data and non-voice data are multiplexed and transported over the single PSTN access line 200 from the various components at the transmission end to the components at the receiving end in a format that is substantially similar to asynchronous transfer mode (ATM). More particularly, the voice and non-voice data are multiplexed and transported over a single PSTN access line in accordance with an adaptation of ATM known as ATM adaption layer “two” (AAL2).

ATM is based on the transmission of data in fixed length data packets known as ATM cells. The format of each ATM cell is the same, wherein each cell contains a 5 octet header portion and a 48 octet payload portion. ATM is generally well-known in the art, and is commonly used for the transportation of telecommunications data in cellular systems.

Because the length of each ATM cell is fixed, ATM does not efficiently utilize available bandwidth when the transportation of low bit-rate data, such as voice data, is involved. To improve ATM bandwidth efficiency, the cellular telecommunications industry has developed a number of ATM adaptation techniques. One of these adaptation techniques is AAL2. Before transporting low bit-rate data from any number of independent, low bit-rate data sources, AAL2 first compresses the low bit rate data from each source and then inserts the compressed data into relatively small, variable length data packets known as minicells or microcells. The format of a minicell is similar to that of an ATM cell, in that each minicell has a header portion and a payload portion. The format of a minicell is different from an ATM cell in that the length of each minicell may vary, whereas the length of an ATM cell is fixed, as mentioned above. In accordance with AAL2, the minicells from each of the data sources are multiplexed into a single data stream, and then inserted into the payload of one or more ATM cells. The ATM cells are then transported to a receiving entity, where the minicells are removed from each ATM cell and disassembled or rerouted according to routing information stored in the header portion of each minicell.

In order to simultaneously and independently transmit voice and non-voice data over a single PSTN access line, the present invention packetizes the voice and non-voice data generated by the components located at the transmission end of the PSTN access line 200, in FIG. 2A, into minicells, which are then multiplexed into a single data stream, as illustrated by the sequence of minicells 225 in FIG. 2B, and transmitted to the appropriate components at the receiving end of the single PSTN access line 200. In order to maximize bandwidth utilization, the voice data is first compressed by the voice compression algorithms stored in the codec 209.

Like the minicell format employed by AAL2, the minicells generated in the present invention contain both a payload portion and a header portion. The payload portion contains the data to be transmitted to the receiving components, while the header portion contains, among other things, a channel identification code (CID). The numbers “1”, “2” and “3” depicted in the minicell headers in minicell stream 225 represent the CID for the corresponding minicell. For example, the CID for the minicell 227 is “1”, thus indicating that the data contained in the payload portion of the minicell 227 corresponds to channel “1” and is, therefore, non-voice computer or internet data. The CID for the minicell 229 is “2”, thus indicating that the data contained in the payload portion of the minicell 229 corresponds to channel “2” and is, therefore, voice data from telephone 207. The CID associated with the minicell 231 is “3”, thus indicating that the data contained in the minicell 231 is signaling data. The signaling data provides the information necessary to set-up and/or terminate each independent telecommunication connection. For example, the data stored in the payload portion of the minicell 231 may indicate that the telephone connection associated with channel “2” is now closed or terminated.

The header portion of each minicell also contains a length indicator code (LIC). More specifically, the LIC defines the exact length of the payload associated with each minicell, as illustrated by the arrows 233 and 235 in FIG. 2B. The LIC may, for example, identify the length of the corresponding payload by identifying the number of octets which make up the payload. This information is used by the demultiplexer 215 at the receiving end of the PSTN access line 200 to delineate the boundary of each minicell received, and to properly route complete data packets to the intended receiving entities.

The header portion of each minicell may also include a checksum value. The checksum value is computed at the transmission source and is typically a function of the contents of the header. The computed checksum value is then inserted into the header portion. At the receiving end, the checksum is recomputed based on what the receiver believes is the correct header information. The receiver then compares the checksum in the header portion of the minicell with the checksum it computed. If the two checksums match, there is a high probability that the transmitting and receiving ends are properly synchronized.

In an alternative embodiment, ATM cells may be employed as a bearer for the minicells, as is known in the cellular telecommunications industry and fully described in, for example, the ATM Forum ITU-T I.363.2 Draft Recommendation for AAL2. Of course, there is a small penalty in terms of bandwidth when using ATM cells as a bearer for the minicells. That is because each ATM cell has its own 5 octet header portion, and wherein the ATM cell has a fixed payload length of 48 octets. The 5 octet header is likely to result in approximately a 10 percent decrease in bandwidth utilization. However, the added benefit of using ATM as a bearer is that minicell delineation is far more accurate. This is because the ATM header generally includes a pointer to the beginning of the first complete minicell stored in the ATM cell payload.

In another alternative embodiment of the present invention, high level data link controller (HDLC) frames may be used as a bearer for the minicells. Minicell delineation may be accomplished as described above, that is by relying upon the LIC in each minicell header as well as the checksum values. The structure and format of an HDLC frame, like ATM, is well known in the art. It should be noted that protocols other than ATM and HDLC may be employed for transporting and delineating minicells, and the incorporation of any one of these alternative protocols into the present invention is considered to be within the scope of the present invention.

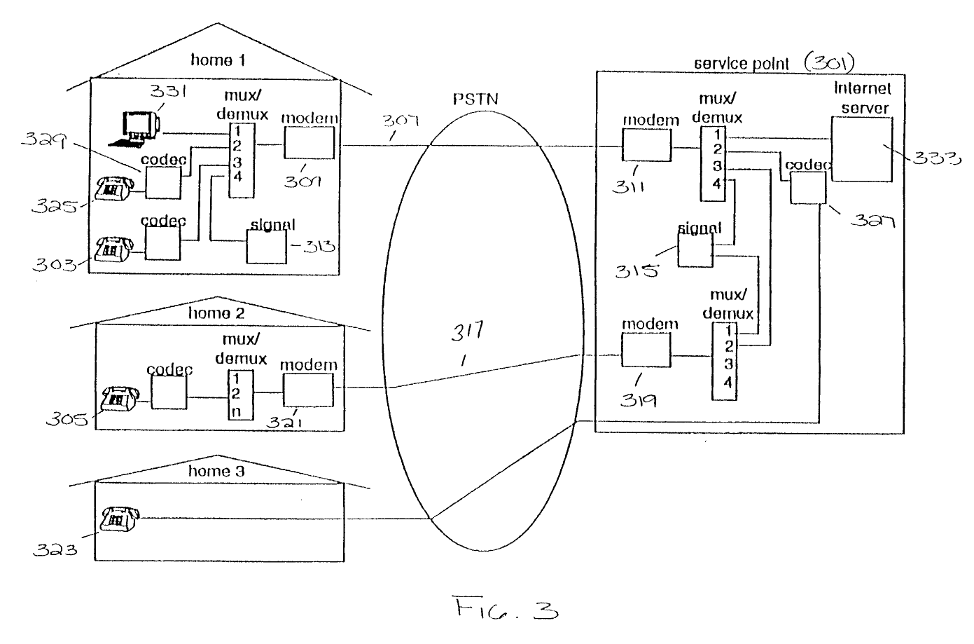

In accordance with another aspect of the present invention, an overlay network comprising one or more service points, for example service point 301, as illustrated in FIG. 3, provides the ability to independently route minicells containing voice data and minicells containing non-voice data from a single PSTN access line to distinctly different end-users. Unlike previous designs, the end-users may be physically separate entities, each being serviced by a distinctly different PSTN line. Moreover, the overlay network is connected to the PSTN in such a way that the added capability described above is completely transparent to the PSTN, which continues to provide “plain old telephony service” (POTS).

The overlay network essentially serves as a proxy agent for certain telephone connections. The function of the overlay network is best described by example with reference to FIG. 3. In a first example, if the telephone 303 in home “1” is used to place a call to the telephone 305 in home “2” and the PSTN access line 307 is idle, the calling party may opt to by-pass the overlay network, including service point 301, and place the call directly through the PSTN using POTS. If this occurs, other individuals in home “1”will be precluded from simultaneously and independently transmitting or receiving data over the PSTN access line 307.

In a second example, the calling party in home “1” may opt to place the call through the overlay network, including service point 301. This may require that the calling party provide a special access code in addition to the telephone number of the called party in home “2”. Assuming the PSTN access line 307 is still idle, a normal call is placed to the service point 301. When a connection between home “1” and the service point 301 is established, the modem 309 in home “1” and the modem 311 in the service point 301 must agree on a data transmission rate. The minicell signaling channel is used to transport information about the called party (i.e., the telephone number of the called party) from the signal terminal 313 in home “1” to the signal terminal 315 in the service point 301. If the called party is connected to the service point 301, as illustrated in FIG. 3, and the PSTN access line 317 is idle, the service point 301 will place an ordinary call over the PSTN to the telephone 305 in home “2”. After the modem 319 in the service point 301 and the modem 321 in home “2” agree on a data transmission rate, the service point 301 interconnects telephone 303 in home “1” with the telephone 305 in home “2”. It should be apparent to those skilled in the art that the data transmission rate between the modems 309 and the modem 311 may be different from the data transmission rate between the modem 319 and the modem 321.

In another example, the telephone 323 in home “3” is used to place a call to home “1” while telephone 303 in home “1” is already connected to the telephone 305 in home “2” as described above. It is likely that home “3” is completely unaware that the overlay network exists. As such, the calling party in home “3” simply places a call to the listed telephone number for home “1” without entering a special access code for the service point 301. However, the PSTN operator is configured to route all calls to home “1” through the service point 301, as is well understood in the art. The service point 301 then forwards a call setup message from the signaling terminal 315 over the signaling channel to the signal terminal 313 in home “1”. The signal terminal 313 in home “1” then forwards the call to the idle telephone 325 connected to channel “2”. Accordingly, minicells containing voice data associated with this connection will be routed to and from the telephone 325. Simultaneously and independently, minicells carrying voice data associated with the previously established connection will be routed to and from the telephone 303.

The service point 301 and the signal terminal 313 in home “1” also determine which codec algorithms to use, given the current load on the connection between modem 309 in home “1” and the modem 311 in the service point 301. In addition, the signaling terminal 315 instructs the codec 327 in the service point 301 to convert the POTS line from home “3” to the compressed speech expected by the codec 329 in home “1”.

In yet another example, a user may wish to use the personal computer 331 in home “1” to access the internet at the same time the telephone 325 in home “1” is connected to the telephone 323 in home “3”, and/or at the same time the telephone 303 is connected to the telephone 305 in home “2”. To accomplish this, the user in home “1” initiates a call through the personal computer 331, for example, to the internet server 333 in the service point 301. Once again, the signal terminal 313 in home “1” causes information about the called party (i.e., the internet server 333) to be transported via minicells to the signaling terminal 315 in the service point 301. The signaling terminal 315 in the service point 301 then forwards the call from the personal computer 331 to the internet server 333. Accordingly, all of the minicells associated with the connection established between the personal computer 331 and the internet server 333 are properly routed based on the routing information stored in the header of each minicell.

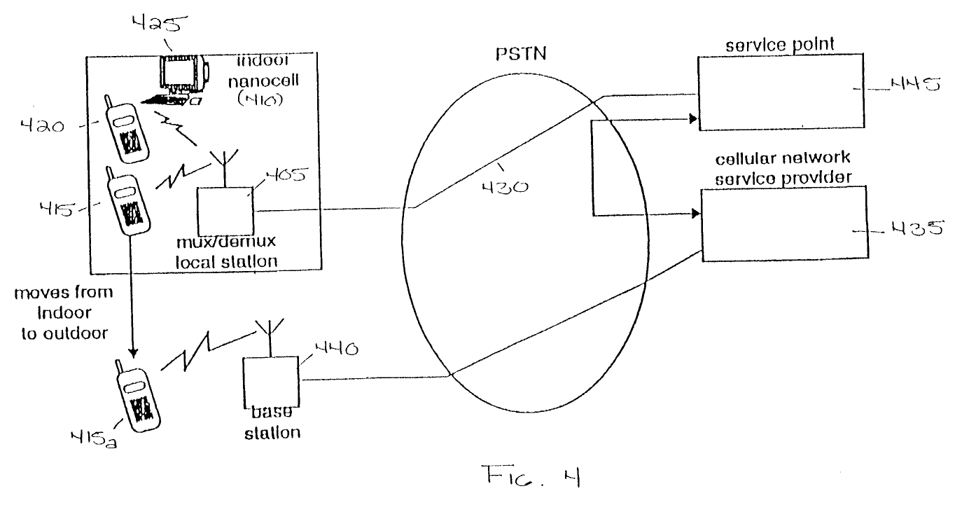

In accordance with another aspect of the present invention, and as illustrated in FIG. 4, the multiplexer and demultiplexer functions may be combined with a local cellular radiotelephone transceiver station 405. As shown in FIG. 4, the local cellular radiotelephone transceiver station 405 provides coverage for a relatively small operating region such as a house or office. Small, localized operating regions such as this are commonly referred to as picocells or nanocells, for example, indoor nanocell 410. The mobile units 415 and 420 and the personal computer 425 operating within the nanocell 410 communicate with the local cellular radiotelephone transceiver station 405 through a wireless air interface. Also, the algorithms which are needed to provide voice compression, as explained above, may be incorporated into the mobile units 415 and 420, as is well known in the art. However, other than transmitting voice and non-voice data through an air interface, the mobile units 415 and 420 and the personal computer 425 are able to simultaneously and independently communicate with distinctly different end-users while sharing a common PSTN access line 430.

Many mobile telephones are capable of operating in a dual-mode. For example, when the mobile telephone 415 is operating from inside the nanocell 410, it is covered by the local cellular radiotelephone transceiver station 405, and it is associated with an identification number from a numbering plan controlled by the PSTN service provider. However, when the mobile telephone 415 moves outside the indoor nanocell 410, as illustrated by mobile telephone 415a, the mobile telephone 415a becomes logically connected to a cellular network provider 435 through a base station 440, as is known in the art. When operating outside the indoor nanocell 410, the mobile telephone 415a is associated with a different identification number issued by the cellular service provider 435. Accordingly, the mobile telephone can operate both indoors and outdoors. Furthermore, the transition from within the nanocell 410 to a location outside the nanocell 410 may be automatically accomplished through a mobile assisted hand-off (MAHO) function, which is well known in the art. However, the service point, for example, service point 445, must be able to communicate with the cellular service provider 435. The service point 445 would communicate with the cellular service provider 435 in much the same way that the service point 301, in FIG. 3 communicated with the various households “1 ”, “2” and “3”.

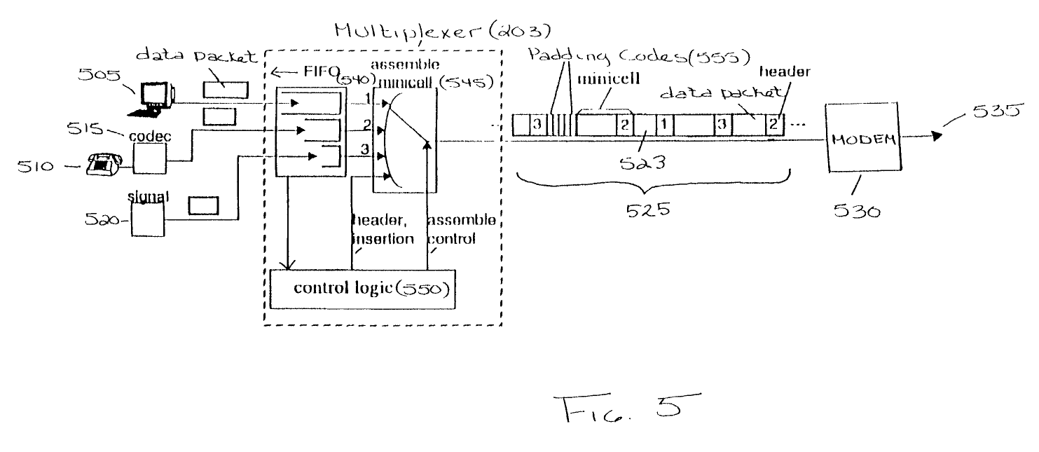

FIG. 5 illustrates an exemplary embodiment for a multiplexer, such as the multiplexer 203 shown in FIG. 2. The purpose of the multiplexer 203, as one skilled in the art will understand, is to receive data packets from the voice and/or non-voice sources which may be operating simultaneously. In the example of FIG. 5, the various voice and non-voice sources include a computer 505, a telephone 510 with a corresponding codec 515, and a signaling unit 520. The multiplexer 203 assembles the data packets into one or more minicells, for example minicell 523, and inserts the minicells into a single data stream 525, as illustrated. The data stream 525 is then appropriately modulated by the modem 530 so that the data is compatible with the single PSTN access line 535.

The multiplexer 203 contains a number of components. Among these components are an input buffer, such as the first-in-first-out (FIFO) buffer 540, a minicell assembly module 545, and a control logic unit 550.

The FIFO 540 may be implemented using a single memory device, as is well known in the art. The purpose of the FIFO 540 is to buffer the data being produced by the voice and non-voice data sources, and to prevent the loss of data due to a difference in the rate at which data is generated by the data sources compared with the rate at which the data is being transmitted over the data link (i.e., the PSTN access line 535). To prevent data loss in general, the size (i.e., the depth) of the FIFO 540 must increase if the rate at which data is being generated increases relative to the rate at which data is being transmitted over the data link.

The control logic unit 550 and the minicell assembly module 545 work in conjunction with each other to transform the data packets, stored in the FIFO 540, into minicells and to multiplex those minicells into a single data stream. Upon receiving a data packet from one of the voice and/or non-voice sources, the FIFO 540 sends a control signal to the control logic unit 550. The control logic unit 550, in turn, commands the minicell assembly module 545 to select the data packet, thereby initiating the process of transforming the data packet into a minicell format. However, if there is more than one data packet stored in the FIFO 540, the control logic unit 550 commands the minicell assembly module 545 to select the data packets in accordance with a predefined priority scheme. Generally, data packets associated with voice data sources are assigned a higher priority than data packets associated with non-voice sources, as voice data is highly sensitive to transmission delays.

After the minicell assembly module 545 selects a data packet, the control logic unit 550 generates an appropriate minicell header. The minicell assembly module 545 then synthesizes a corresponding minicell by “attaching” the header to the selected data packet. In accordance with the AAL2 protocol described above, the header includes a CID code, a length field and a CRC. The information used to formulate the CID code may be provided by the FIFO 540. For example, in FIG. 5, if the data packet is stored in the upper-most FIFO queue, it must be associated with the computer 505. Accordingly, the corresponding header must contain a CID code that reflects the computer 505, e.g., a CID code of “1”. If the data packet is stored in the middle FIFO queue and is associated with the telephone 510, the header will contain a CID code of “2”. If the data packet is stored in the lower-most FIFO queue and is associated with the signaling unit 520, the header will contain a CID code of “3”. The information used to formulate the value in the length field of the header is a function of the number of FIFO queue storage locations needed to store the entire data packet. Finally, the CRC is computed by the control logic unit 550, as a function of the various codes and field values that make up the remaining portion of the header, as is well known in the art.

FIG. 5 also illustrates that the multiplexer 203 continuously transmits the single data stream 525, which comprises the minicells synthesized by the minicell assembly module 545, to the modem 530. It should be noted that if, at any given time, there are no data packets stored in the FIFO 540, the control logic unit 550 causes the minicell assembly module 545 to fill the single data stream 525 with padding codes 555. The padding codes 555 help delineate the minicell boundaries and maintain a synchronous data transmission. The modem 530, as one skilled in the art will readily appreciate, modulates the data associated with the single data stream 525. A transmitter (not shown) then transmits the single data stream 525 over the single PSTN access line 535.

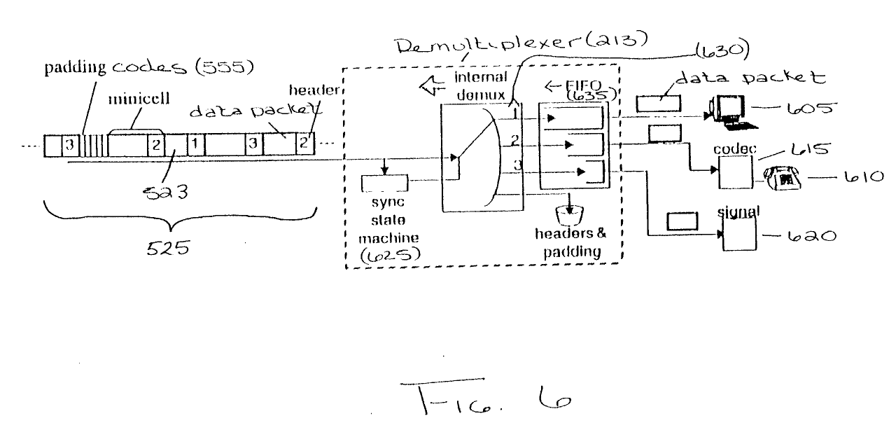

FIG. 6 illustrates an exemplary embodiment for a demultiplexer, such as the demultiplexer 215 shown in FIG. 2A. The purpose of the demultiplexer 215, as one skilled in the art will understand, is to receive the single data stream 525, transmitted across the single PSTN access line 535 (not shown) and demodulated by a modem (not shown), to disassemble the minicells, and to route the data packets associated with the minicells to the appropriate voice and/or non-voice destination. In the example of FIG. 6, the various voice and non-voice destinations include a computer 605, a telephone 610 with corresponding codec 615, and a signaling unit 620. As illustrated in FIG. 3, the destination might also be an internet server 333.

The demultiplexer 213 contains a number of components. Among these components are a sync-state machine 625, an internal demultiplexer module 630, and a FIFO 635.

The sync-state machine 625 primarily controls the functionality of the demultiplexer 213, in much the same way that the control logic 550 controlled the functionality of the multiplexer 203. More specifically, the sync-state machine 625 delineates the borders of each minicell in the single data stream 525, based on the value stored in the length field of each minicell header; determines whether the minicells contain valid data based on the value of the CRC stored in each minicell header; and commands the internal demultiplexer module 630.

The internal demultiplexer module 630, under the direction of control signals generated by the sync-state machine 625, removes the header from each minicell in the single data stream 525, as illustrated, as well as any padding codes, and then directs the data packets into the appropriate FIFO queue in accordance with the CID code that was stored in the corresponding header. Once a data packet is stored in the FIFO 635, the corresponding voice and/or non-voice destination is notified and the data packet is downloaded from the FIFO 635 to the appropriate destination.

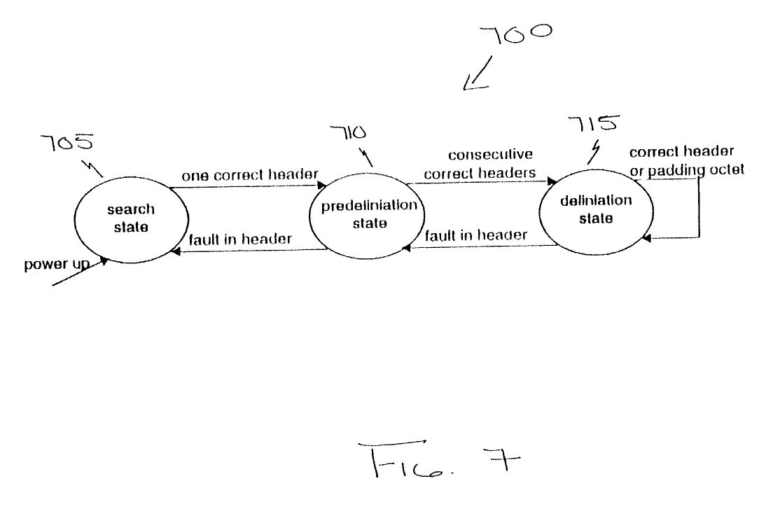

FIG. 7 illustrates an exemplary state diagram 700 for the sync-state machine 625. According to FIG. 7, the sync-state machine 625 is in a search state 705 when power is first applied. In the search state 705, the sync-state machine 625 searches for a first minicell by validating the header portions of the first minicell using the CRC, as one skilled in the art will understand. If the synch-state machine 625 correctly validates the header, the sync-state machine 625 transitions from the search state 705 to the pre-delineation state 710. After the sync-state machine 625 validates a header, the sync-state machine 625 utilizes the length field in that header to delineate the boundary of the corresponding minicell. When the sync-state machine 625 correctly validates a predetermined number of minicell headers consecutively, the sync-state machine 625 transitions from the pre-delineation state 710 to the delineation state 715. If, however, the sync-state machine 625 fails to validate a minicell header while in the pre-delineation state 710 or the delineation state 715, the sync-state machine 625 will transition back to the search state 705 from the pre-delineation state 710 or transition back to the pre-delineation state 710 from the delineation state 715. In accordance with a preferred embodiment of the present invention, the sync-state machine 625, while in either the search state 705 or the pre-delineation state 710, does not forward minicells to the internal demultiplexer 630. Rather, minicells are passed from the sync-state machine 625 to the internal demultiplexer 630 only when the sync-state machine 625 is in the delineation state 715.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for simultaneously transmitting independent data over a single publically switched telephone network (PSTN) access line comprising the steps of:
generating a first data packet;
generating a second data packet, wherein the first data packet is generated by a first data source and the second data packet is generated by a second data source, independent of the first data source;
multiplexing data associated with the first data packet and data associated with the second data packet into a single data stream; and
transmitting the single data stream over the single PSTN access line, wherein the single PSTN access line is commonly shared by the first and the second data sources.

2. The method of claim 1 further comprising the steps of:
generating a first minicell from the first data packet prior to multiplexing the data associated with the first and the second data packets into the single data stream, wherein the first minicell contains the data associated with the first data packet; and
generating a second minicell from the second data packet prior to multiplexing the data associated with the first and the second data packets into the single data stream, wherein the second minicell contains the data associated with the second data packet.

3. The method of claim 2 further comprising the steps of:
routing the data associated with the first minicell from the single PSTN access line to a first destination as a function of information stored in a header portion of the first minicell; and
routing the data associated with the second minicell from the single PSTN access line to a second destination, independent of the first destination, as a function of information stored in a header portion of the second minicell.

4. The method of claim 2, wherein the step of multiplexing the data associated with the first data packet and the data associated with the second data packet comprises the step of:
multiplexing the first minicell and the second minicell into the single data stream.

5. The method of claim 4, wherein the step of multiplexing the first minicell and the second minicell into the single data stream comprises the step of:
inserting the first minicell and the second minicell into an Asynchronous Transfer Mode cell.

6. The method of claim 4, wherein the step of multiplexing the first minicell and the second minicell into the single data stream comprises the step of:
inserting the first minicell and the second minicell into a high level data link controller frame.

7. A method for establishing a plurality of telecommunications connections over a single, commonly shared publically switched telephone network (PSTN) access line comprising the steps of:
establishing a telecommunications link between a first and a second end-user, wherein the first end-user terminal is serviced by a PSTN access line;
establishing a telecommunications link between a third and a fourth end-user, independent of the telecommunications link between the first and the second end-user, wherein the third end-user is serviced by the PSTN access line;
generating a first sequence of minicells associated with the first end-user;
generating a second sequence of minicells associated with the third end-user;
transmitting the first sequence of minicells from the first end-user to the second end-user over the PSTN access line; and
transmitting the second sequence of minicells from the third end-user to the fourth end-user over the PSTN access line, wherein the second sequence of minicells and the first sequence of minicells are transmitted over the PSTN access line simultaneously.

8. The method of claim 7 further comprising the step of:
multiplexing the first and the second sequence of minicells prior to the simultaneous transmission of the first and the second minicell sequences over the PSTN access line.

9. The method of claim 7 further comprising the step of:
routing the first sequence of minicells from the PSTN access line to the second end-user and routing the second sequence of minicells from the PSTN access line to the fourth end-user based on routing information stored in a header portion of each minicell.

10. The method of claim 7, wherein the data associated with the first end-user is non-voice data, and wherein the data associated with the third end-user is voice data.

11. The method of claim 10, wherein the first end-user is a computer.

12. The method of claim 11, wherein the second end-user is an internet server.

13. The method of claim 10, wherein the third end-user and the fourth end-user are telephones.

14. An apparatus for simultaneously transmitting independent data over a single publically switched telephone network (PSTN) access line comprising the steps of:
a first data source means for generating a first data packet;
a second data source means for generating a second data packet, wherein the second data source means generates the second data packet independent of the first data source means, and the first data source means generates the first data packet independent of the second data source means;
means for multiplexing data associated with the first data packet and data associated with the second data packet into a single data stream; and
means for transmitting the single data stream over the single PSTN access line, wherein the single PSTN access line is commonly shared by the first and the second data sources.

15. The apparatus of claim 14 further comprising:
assembly means for generating a first minicell from the first data packet and a second minicell from the second data packet prior to multiplexing the first and the second data packets into the single data stream, wherein the first minicell contains the data associated with the first data packet and the second minicell contains the data associated with the second data packet.

16. The apparatus of claim 15 further comprising:
means for routing the data associated with the first minicell from the single PSTN access line to a first destination as a function of information stored in a header portion of the first minicell, and for routing the data associated with the second minicell from the single PSTN access line to a second destination, independent of the first destination, as a function of information stored in a header portion of the second minicell.

17. The apparatus of claim 15, wherein said means for multiplexing data associated with the first data packet and data associated with the second data packet into the single data stream comprises:
means for multiplexing the first minicell and the second minicell into the single data stream.

18. The apparatus of claim 17, wherein said means for multiplexing the first minicell and the second minicell into the single data stream comprises:
means for inserting the first minicell and the second minicell into an Asynchronous Transfer Mode cell.

19. The apparatus of claim 17, wherein said means for multiplexing the first minicell and the second minicell into the single data stream comprises:
means for inserting the first minicell and the second minicell into a high level data link controller frame.

20. An apparatus for establishing a plurality of telecommunications connections over a single, commonly shared publically switched telephone network (PSTN) access line comprising:
means for establishing a first telecommunications link between a first and a second end-user, wherein the first end-user terminal is serviced by a PSTN access line;
means for establishing a second telecommunications link between a third and a fourth end-user, independent of the first telecommunications link, wherein the third end-user is, simultaneous to the first end-user, serviced by the PSTN access line;
means for generating a first sequence of minicells associated with the first telecommunications link, and for generating a second sequence of minicells associated with the second telecommunications link;
means for transmitting the first sequence of minicells over the PSTN access line; and
means for transmitting the second sequence of minicells over the PSTN access line, wherein the second sequence of minicells and the first sequence of minicells are transmitted over the PSTN access line simultaneously.

21. The apparatus of claim 20 further comprising:
means for multiplexing the first and the second sequence of minicells prior to the simultaneous transmission of the first and the second minicell sequences over the PSTN access line.

22. The apparatus of claim 20 further comprising:
means for routing the first sequence of minicells from the PSTN access line to the second end-user and routing the second sequence of minicells from the PSTN access line to the fourth end-user based on routing information stored in a header portion of each minicell.

23. The apparatus of claim 20, wherein the data associated with the first telecommunications link is non-voice data, and wherein the data associated with the second telecommunications link is voice data.

24. The apparatus of claim 23, wherein the first end-user is a computer.

25. The apparatus of claim 24, wherein the second end-user is an internet server.

26. The apparatus of claim 23, wherein the third end-user and the fourth end-user are telephones.

27. A system for simultaneously transmitting voice and non-voice data over a single publically switched telephone network (PSTN) access line comprising:
a first data source capable of generating a first data packet, wherein the first data packet contains voice data;
a second data source capable of generating a second data packet independent of the first data source generating the first data packet, wherein the second data packet contains non-voice data;
multiplexer for receiving the first data packet and the second data packet, and for multiplexing the voice data associated with the first data packet and the non-voice data associated with the second data packet into a single data stream; and
means for transmitting the single data stream over the single PSTN access line, wherein the single PSTN access line is commonly shared by the first and the second data sources.

28. The system of claim 27, wherein said multiplexer comprises:
means for generating a first minicell from the voice data associated with the first data packet prior to multiplexing the voice and non-voice data into the single data stream; and
means for generating a second minicell from the non-voice data associated with the second data packet prior to multiplexing the voice and non-voice data into the single data stream.

29. The system of claim 28 further comprising:
demultiplexer for receiving the single data stream, wherein said demultiplexer comprises means for routing the voice data associated with the first minicell to a first destination as a function of information stored in a header portion of the first minicell, and means for routing the non-voice data associated with the second minicell to a second destination as a function of information stored in a header portion of the second minicell.

30. The system of claim 28, wherein said multiplexer further comprises:
means for inserting the first and the second minicells into an Asynchronous Transfer Mode cell.

31. The system of claim 28, wherein said multiplexer further comprises:
means for inserting the first and the second minicells into a high level data link controller frame.

32. A system for simultaneously transmitting voice and non-voice data over a publically switched telephone network (PSTN) comprising:
a first telecommunications terminal capable of generating minicells containing voice data;
a second telecommunications terminal capable of generating minicells containing non-voice data, independent of the first telecommunications terminal;
multiplexer connected to said first and said second telecommunications terminals, wherein said multiplexer generates a single stream of minicells from the minicells generated by said first and said second telecommunications terminals; and
a single PSTN access line connecting said multiplexer to an overlay network, wherein the overlay network routes the minicells containing voice data to a third telecommunications terminal and the minicells containing the non-voice data to a fourth telecommunications terminal, and wherein the third and the fourth telecommunications terminals operate independent of each other.

33. The system of claim 32, wherein the overlay network comprises one or more service points, and wherein a service point contains a demultiplexer for receiving the single stream of minicells from the single PSTN access line and for separating the minicells containing voice data from the minicells containing non-voice data.

34. The system of claim 32 further comprising:
a modem located at either end of the PSTN access line for modulating and demodulating the voice and non-voice data so that it is compatible with the PSTN access line.

35. The system of claim 32 further comprising:
a signaling terminal at either end of the PSTN access line for generating call setup messages between telecommunications terminals.

36. The system of claim 32, wherein the first telecommunications terminal is a telephone and the second telecommunications terminal is a personal computer.

37. The system of claim 32, wherein the third telecommunications terminal is a telephone and the fourth telecommunications terminal is an internet server.

38. The system of claim 37, wherein the first and the second telecommunications terminals are co-located in the same physical location.

39. The system of claim 32 further comprising:
a radiotelecommunications transceiver connected to said first and said second telecommunications terminals through an air interface, wherein said radiotelecommunications transceiver is connected to said PSTN access line, and wherein said multiplexer is contained within said radiotelecommunications transceiver.

40. The system of claim 39, wherein said first and said second telecommunications terminals are co-located in a telecommunications nanocell.

41. The system of claim 39, wherein the overlay network is connected to a cellular service provider through the PSTN.
